(19) United States
(12) Patent Application Publication
(10) Pub. No.: US 2008/0295151 A1
(43) Pub. Date: Nov. 27, 2008

(54) METHOD AND SYSTEM FOR ANONYMOUS INFORMATION VERIFICATION

(75) Inventor: Tiejun Xia, Richardson, TX (US)

Correspondence Address: Tiejun Xia, 3909 Compton Drive, Richardson, TX, 75082, US

(73) Assignee: Tiejun Jay Xia, Richardson, TX (US)

(21) Appl. No.: 12/050,151

(22) Filed: Mar. 17, 2008

Related U.S. Application Data
(60) Provisional application No. 60/895,479, filed on Mar. 18, 2007.

(51) Int. Cl. H04L 9/32

(52) U.S. Cl. 726/2

(57) ABSTRACT

A first user contacts a verification host and claims that an item of the first user's information is in a predefined range with relevant information submitted. The verification host verifies the first user's claim, and provides a code generator to the first user if the claim is valid. The first user generates a code by running the code generator with an input only known to the first user. The code generator combines an input determined by the verification host and the input by the first user into a combined input, encrypts the combined input, and generates a code based on the encrypted combined input. The generated code contains a first portion, which is determined by the verification host and contains no any first user's information, and a second portion, which is related to the first user's input when running the code generator. Only the first user knows that the generated code belongs to the first user. A second user contacts the verification host to obtain a code verifier for a need to verify that the item of the first user's information is in the predefined range. The verification host provides a code verifier to the second user. When the second user needs to verify that an item of the first user's information is in a predefined range, the second user only needs to verify the relevant code submitted by the first user by running the code verifier. The code verifier decrypts the code submitted by the first user, compares a part of the code verifier determined by the verification host, which contains no any first user's information, with the first portion of the decrypted code, and return a result to the second user. The first user's identity and privacy are fully protected during the code verification process with the method and system disclosed here.

### FIELD OF THE INVENTION

Implementations consistent with the principles of the invention relate generally to a person or an organization who wants to verify that an item of another person's information or another organization's information falls into a predefined range while the latter's identity is not revealed to anyone during the verification process.

### BACKGROUND OF THE INVENTION

For some types of services the service providers are required to verify that an item of a consumer's personal information must fall into a predefined range before providing the service to the consumer. For example, a tobacco retailer must verify that a consumer's age falls into a predefined range, for example, 21 or above, before selling cigarettes to the consumer. Normally a driver license card or a personal identification card issued by the government can be used to fulfill the purpose, even though the driver license provides more information, the exact date of birth, than the needed. In recent years the e-business on Internet is booming. A lot of businesses now are able to offer services to consumers through Internet, including the special businesses, such as tobacco sales, alcohol sales, adult entertainment, etc. For businesses on Internet the traditional way to verify personal information by showing driver license card is no longer easy, because people hesitate to give their personal information to a website host they do not know much and do not feel comfortable when the website may record their activities on the website. However, verification of personal information is still a requirement for doing the businesses; therefore it has been taking a different approach for the verification. For example, before entering these websites, the consumer may be required to click the button YES to the questions like “Are you over 21 years of age?” or click a bar with words like “I am over 18, let me see the good stuff”, to gain the access to the website. In this way it is the consumer's responsibility to tell the truth and to follow the law. Without consumer's personal information the website cannot verify the customer's answer.

The purpose of the approaches mentioned in above examples is to protect children under the predefined age from accessing the websites. The approach, however, does not work well. If a child under the age clicks the button YES and accesses the website, the law enforcement cannot hold responsibility of the child, as the child may not have full legal responsibility yet; the law enforcement cannot hold responsibility of the website host either, as the website host has required the consumer to take the oath. The most important thing here is not to argue who should be blamed but to find a practical approach to protect children and protect consumer's privacy in the same time.

The present disclosure provides a general method and system for verifying that an item of a person's information or an organization's information falls into a predefined range without leaking the identity of the person or the organization to anyone during the verification process. For example, with this method and system, a website can be sure that a visiting consumer is 18 or above while no body in the world knows the consumer has visited the website except the consumer himself/herself. In other words, the verification is absolutely anonymous. This approach is different from other anonymous verification methods, in which normally a middle-man is involved to translate the information between the service provider and the consumer. In the middle-man approach, even though the service provider may not know the identity of the consumer for the consumer's action, however, the consumer's identity and activity is exposed to at least the middle-man.

### SUMMARY OF THE INVENTION

In an implementation consistent with the principles of the invention, a method and a system include a verification host, which provides services related to code generation and code verification, a first user, who wants to use the method to generate a code, a second user, who wants to use the method to verify a code, a database, which serves for an initial verification in the method, a code, which will be used by the first user, a code generator, which helps the first user to generate the code, and a code verifier, which helps the second user to verify the code. In this implementation the first user contacts a verification host and claims that an item of the first user's information falls into a predefined range. The first user submits relevant information to the verification host. Then the verification host verifies the first user's claim by comparing the information submitted by the first user with that in a database. If the first user's claim is true, the verification host supplies the code generator, which contains no any first user's information, to the first user. Then the first user uses an input only known to the first user when running the code generator. The code generator generates the code for the first user. Only the first user, no one else, including the verification host, knows that the code belongs to the first user. The first user keeps the code for verification purpose that the item of the first user's information falls into the predefined range. When the second user needs to verify that the item of the first user's information falls into the predefined range, the verification host authorizes the second user to use the code verifier, which contains no any first user's information either. The first user only needs to submit the code relevant to the item of information and relevant to the range to the second user. Then the second user runs the code verifier with the code submitted by the first user. The second user uses the result generated by the code verifier as a base for verification that the item of the first user's information does fall into the predefined range.

An implementation consistent with the principles of the invention has the following properties: (1) the code is long enough, therefore the probability to guess a valid code is extremely small; (2) the input that the first user uses when running the code generator is complicated enough, therefore the probability that two first users' codes are the same is extremely small; (3) the code generator can only generate one code for the same item of information and for the same range for each time the first user contacts the verification host, therefore the first user only has one code for the same item of information and for the same range; (4) the code generator and the code verifier are highly encrypted, therefore the probability to breakdown them by an unauthorized entity is extremely small; (5) code abuse is monitored and stopped with built-in anti-code-abuse mechanism; (6) the code, the code generator and the code verifier need to be renewed for certain time periods, therefore the probability to forge the code, the code generator and the code verifier by an unauthorized entity is extremely small; (7) the first user and the second user are not mutually exclusive. An entity could be the first user and the second user; (8) the first user can have multiple codes for different items of information and different ranges and the second user may be able to verify multiple codes for different items of information, different ranges, and different first users; and (9) the second user, the verification host, and the database may present in various combinations. For example, the verification host and the database may be combined into one entity. In another example, the verification host and the second user may be combined into one entity capable of implementing the original functions of the both at different times, such as providing a code generator at one time and running a code verifier at a later time, while still compliant to the principle of the invention as an anonymous verification.

### BRIEF DESCRIPTION OF THE DRAWINGS

The accompanying drawings, which are incorporated in and constitute a part of this specification, illustrate embodiments of the invention and, together with the description, explain the invention. In the drawings,

FIG. 1 illustrates an exemplary system in which various apparatus and methods, consistent with the principles of the invention, may be implemented;

FIG. 2 illustrates an exemplary method of anonymous verification consistent with the principles of the invention;

FIG. 3 illustrates an exemplary verification host as indicated in FIG. 1 in an implementation consistent with the principles of the invention;

FIG. 4 illustrates an exemplary code as indicated in FIG. 1 in an implementation consistent with the principles of the invention;

FIG. 5 illustrates an exemplary code generator as indicated in FIG. 1 in an implementation consistent with the principles of the invention;

FIG. 6 illustrates an exemplary code verifier as indicated in FIG. 1 in an implementation consistent with the principles of the invention;

FIG. 7 illustrates an exemplary code generation process as indicated in FIG. 1 in an implementation consistent with the principles of the invention;

FIG. 8 illustrates an exemplary code verification process as indicated in FIG. 1 in an implementation consistent with the principles of the invention;

FIG. 9 illustrates an exemplary process to handle code abuse in an implementation consistent with the principles of the invention;

FIG. 10 illustrates an exemplary design of a code generator and a code verifier as indicated in FIG. 5 in an implementation consistent with the principles of the invention;

FIG. 11 illustrates an exemplary set of numerical values as indicated in FIG. 10 in an implementation consistent with the principles of the invention;

FIG. 12 illustrates an example in which systems and methods, consistent with the principles of the invention, may be implemented;

FIG. 13 illustrates another example in which systems and methods, consistent with the principles of the invention, may be implemented;

FIG. 14 illustrates yet another example in which systems and methods, consistent with the principles of the invention, may be implemented;

FIG. 15 illustrates still another example in which systems and methods, consistent with the principles of the invention, may be implemented.

FIG. 16 illustrates still another example in which systems and methods, consistent with the principles of the invention, may be implemented.

### DETAILED DESCRIPTION

The following detailed description of implementations consistent with the principles of the invention refers to the accompanying drawings. The same reference numbers in different drawings may identify the same or similar elements. Also, the following detailed description does not limit the invention. Instead, the scope of the invention is defined by the appended claims and their equivalents.

Implementations consistent with the principles of the invention provide a generic method and system to generate a code, which can prove that an item of a person's information or an organization's information falls into a predefined range without revealing the person's identity or the organization's identity in the verification process.

### Exemplary System and Method

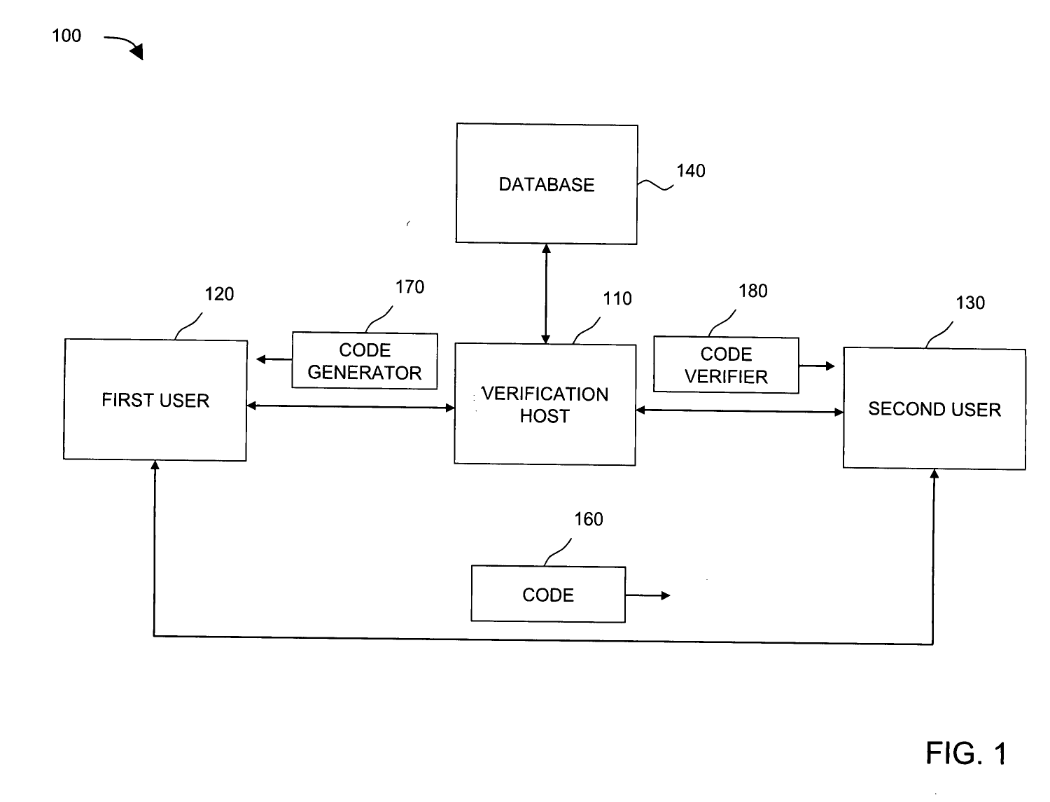

FIG. 1 illustrates an exemplary system 100 in which apparatuses and methods, consistent with the principles of the invention, may be implemented. As illustrated, system 100 may include verification host 110, which provides the services related to code generation and code verification, first user 120, who wants to use the method to generate a code, second user 130, who wants to use the method to verify a code, database 140, with which verification host 110 performs an initial information verification, code 160, code generator 170, and code verifier 180. The number of verification hosts, first users, second users, databases, codes, code generators, and code verifiers, as illustrated in FIG. 1, is provided for simplicity. In practice, a typical system could include more or less verification hosts, first users, second users, databases, codes, code generators, and code verifiers than illustrated in FIG. 1. In other embodiments verification host 110, database 140, and second user 130 may form combinations or include a plurality of sub-modules distributed in various locations and/or entities, configured and coordinated to provide the functions retaining information, providing verification services, and providing commercial or non-commercial services.

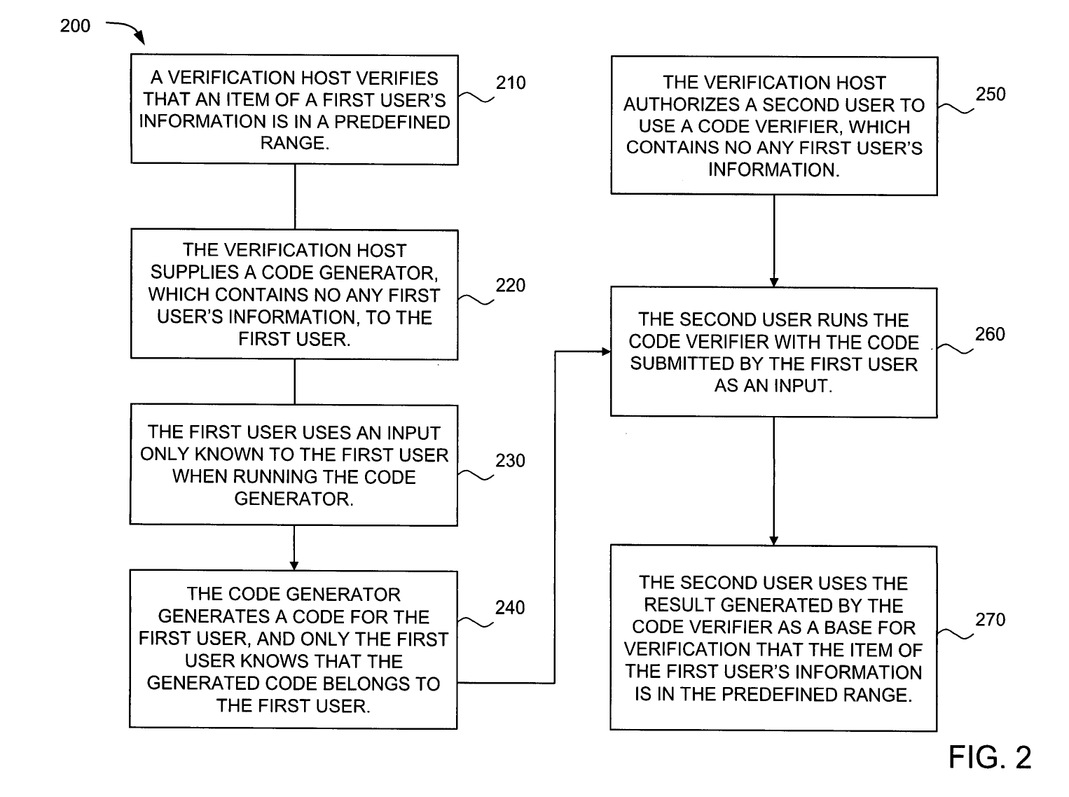

FIG. 2 illustrates an exemplary method 200 consistent with the principles of the invention. As illustrated, method 200 may include step 210 through step 270. The number of steps, as illustrated in FIG. 2, is provided for simplicity. In practice, a typical method could include more or less steps than illustrated in FIG. 2.

Verification host 110 may verify that an item of first user 120's information falls into a predefined range in step 210. If the verification is successful verification host 110 may supply a code generator 170, which contains no any first user's information (except that the item of information of the first user falls into the predefined range), to first user 120 in step 220. Then first user 120 may use an input only known to first user 120 when first user 120 runs code generator 170 in step 230. Then code generator 170 may generate code 160 for first user 120 and only first user 120 knows that the generated code belongs to the first user. Verification host 110 may authorizes second user 130 to use code verifier 180, which contains no any first user's information either, in step 250. When second user 130 needs to verify that an item of first user 120's information falls into a predefined range first user 120 may submit relevant code 160 to second user 130 in step 260. Then second user 130 may run code verifier 180 with code 160 in step 270. Second user 130 may use the result generated by code verifier 180 as a base for verification that the item of first user 120's information does fall into the predefined range. In this method and system, even though verification host 110 knows the identity of first user 120 who has obtained code generator 170, verification host 110, second user 130 or anyone else, except first user 120, has no information about whether or not first user 120 has generated a code, has no information about that generated code belongs to first user 120, has no information about whether or not first user 120 has used, is using, or will use code 160 if it had been generated, and has no information about when and where first user 120 has used, is using, or will use code 160 if it had been generated. Therefore this method and system provide an approach to verify that an item of first user 120's information falls into a predefined range while protecting first user 120's identity and privacy completely.

### Exemplary Verification Host

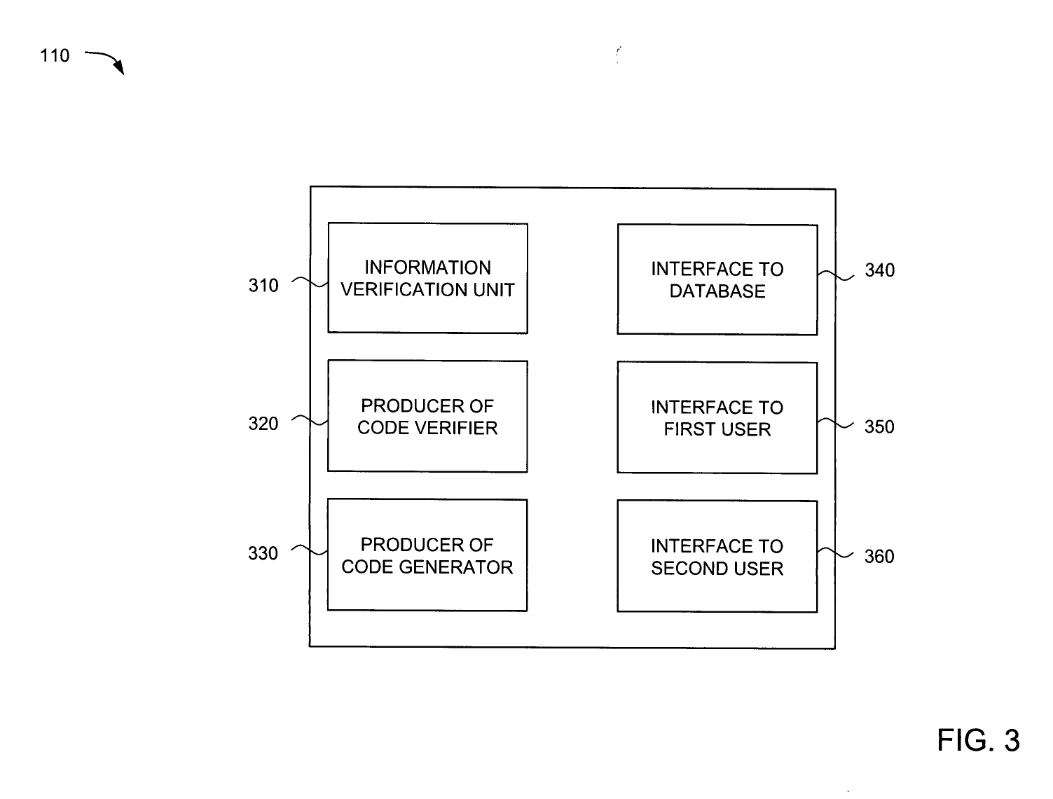

FIG. 3 illustrates an exemplary verification host 110 as illustrated in FIG. 1 in an implementation consistent with the principles of the invention. As illustrated, system 110 may include information verification unit 310, producer 320 of code generator 170, producer 330 of code verifier 180, interface 340 to database 140, interface 350 to first user 120, and interface 360 to second user 130. The number of information verification units, producers of code generators, producers of code verifiers, interfaces to databases, interfaces to first users, and interfaces to second users as illustrated in FIG. 3, is provided for simplicity. In practice, a typical verification host could include more or less information verification units, producers of code generators, producers of code verifiers, interfaces to databases, interfaces to first users, and interfaces to second users than illustrated in FIG. 3. In other embodiments producer 320 of code generator 170 and producer 330 of code verifier 180 may be combined as one entity or verification host 110 may only include interfaces to the producers when the producers are external resources to verification host 110. In other embodiments verification host may include database 140, therefore interface 350 may be an internal interface.

Information verification unit 310 may perform initial information verification for first user 120. Producer 320 of code generator 170 and producer 330 of code verifier 180 may design and develop software for anonymous information verification. For example, internal or external software development teams may become producers 320 and 330. Interface 340 to database 140 may request relevant information for verification purposes. For example, the database of a driver license bureau or the database of a bank is a typical database 140 for interface 340. Interface 350 may interact with first user 120 and interface 360 may interact with second user 130. For example, Internet can be interface 350 and interface 360. A kiosk can be interface 350 and interface 360, too. Interface 350 may accept requests for code generator 170 from first user 120. Interface 360 may accept requests for code verifier 180 from second user 130. Interface 350 may supply code generator 170 to first user 120 and interface 360 may supply code verifier 180 to second user 130. After the initial information verification in step 210 as illustrated in FIG. 2 no entity is able to know first user 120's actions with code generator 170 or with code 160, if code 160 were generated. Therefore first user's identity and privacy are fully protected in code verification process.

### Exemplary Code

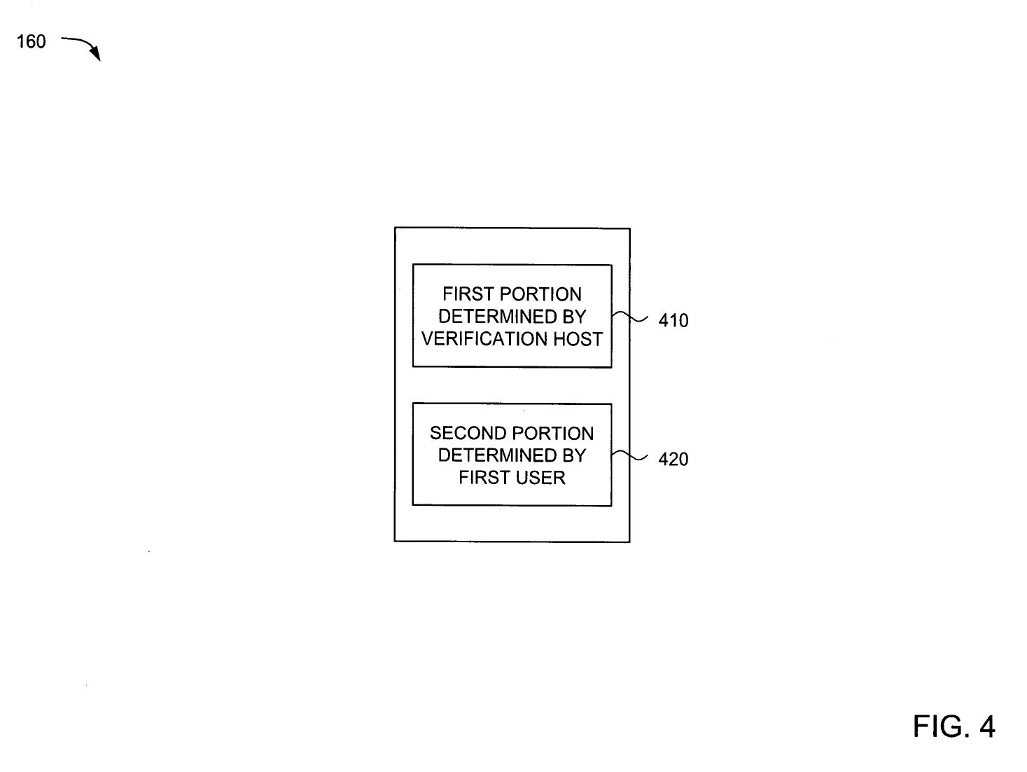

FIG. 4 illustrates an exemplary code 160 as illustrated in FIG. 1 in an implementation consistent with the principles of the invention. As illustrated, code 160 may include first portion 410 determined by verification host 110, and second portion 420 determined by first user 120. The number of first portions and second portions, as illustrated in FIG. 4, is provided for simplicity. In practice, a typical code could include more or less first portions and second portions than illustrated in FIG. 4.

First portion 410 may be something determined by verification host 110. For example, first portion 410 may be a string related to the type of the item of information and the range of the item of information in the verification process. First portion 410 is not related to any first user's information. Second portion 420 may be determined by first user 120. For example, second portion 420 may be a string selected randomly by first user 120 or a set of pictures selected by first user 120 as an input when running code generator 170. Code 160 may be an encrypted combination of first portion 410 and second portion 420. For example, first portion 410 may be a string, second portion 420 may be another string, and combination of the two strings may be a new string. Code 160 may contain the new string encrypted with RSA (Rivest, Shamir, Adleman) Algorithm.

### Exemplary Code Generator and Code Verifier

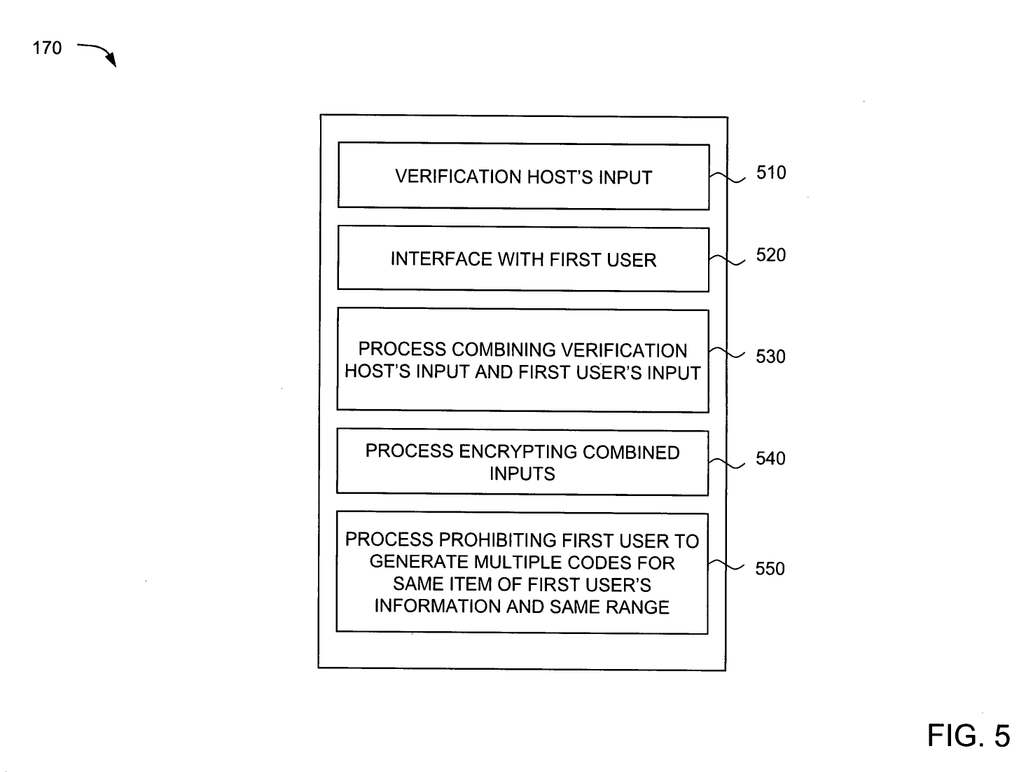

FIG. 5 illustrates an exemplary code generator 170 in an implementation consistent with the principles of the invention. As illustrated, code generator 170 may include module 510 for verification host's input, module 520 for an interface with first user 120, module 530 for combination, module 540 of encryption, and module 550 of prohibition. The number of modules, as illustrated in FIG. 5, is provided for simplicity. In practice, a typical code generator could include more or less modules than illustrated in FIG. 5.

Module 510 may include or be designed to take an input to code 160 determined by verification host 110. Module 510 contains no any first user's information. For example, module 510 may contain a string related to the item of information and the range of the item of information. Module 520 may contain an interface with first user 120. For example, module 520 may contain a graphic user interface (GUI). Module 520 may accept first user 120's input to code generator 170 and release generated code 160 to first user 120. Module 530 may combine verification host input and first user 120's input into a combined input. Module 540 may encrypt the combined input. For example, an encryption process based on RSA (Rivest, Shamir, Adleman) Algorithm may be used with module 540. Module 550 may prohibit first user 120 to generate multiple codes for the same item of information and for the same range for first user 120. For example, a self-deactivating mechanism in code generator 170 may guarantee first user 120 can only run a code generator once. In other example, module 550 may prohibit first user 120 to generate a predefined number of codes for the same item of information and for the same range for first user 120.

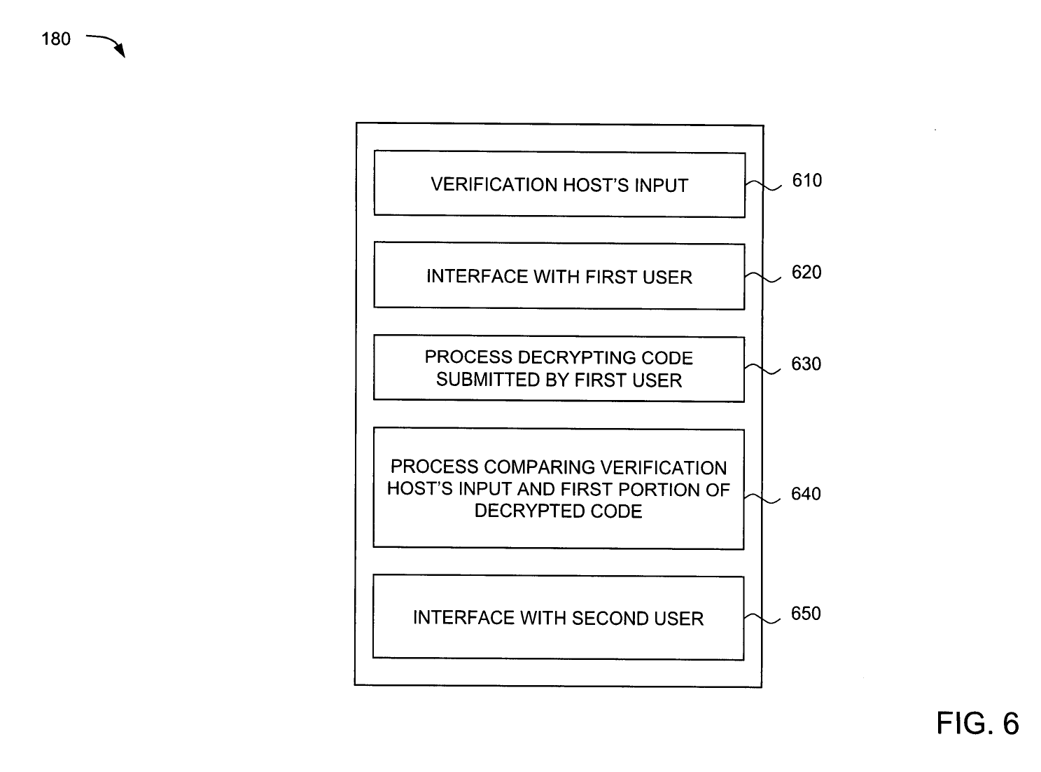

FIG. 6 illustrates an exemplary code verifier 180 in an implementation consistent with the principles of the invention. As illustrated, code verifier 180 may include module 610 for verification host's input, module 620 for an interface with first user 120, module 630 for decryption, module 640 for comparison, and module 650 for an interface with second user 130. The number of modules, as illustrated in FIG. 6, is provided for simplicity. In practice, a typical code verifier could include more or less modules than illustrated in FIG. 6.

Module 610 for verification host's input may include or designed to take an input determined by verification host 110 for code verification purposes. For example, module 610 may contain a string related to the item of information and the range. Module 520 may accept code 160 submitted by first user 120. Module 630 may decrypt the submitted code. For example, a decryption process based on RSA (Rivest, Shamir, Adleman) Algorithm may be used. Module 640 may compare verification host's input and first portion 410 of the decrypted code. Module 640 may determine whether or not the submitted code is a valid code based on whether or not verification host's input 610 and first portion 410 of the decrypted code are consistent. The validation of the submitted code may directly relate to the validation of the submitted code. Module 650 may inform second user 130 the result of verifying the code submitted by first user 120.

### Exemplary Code Generation and Verification Processes

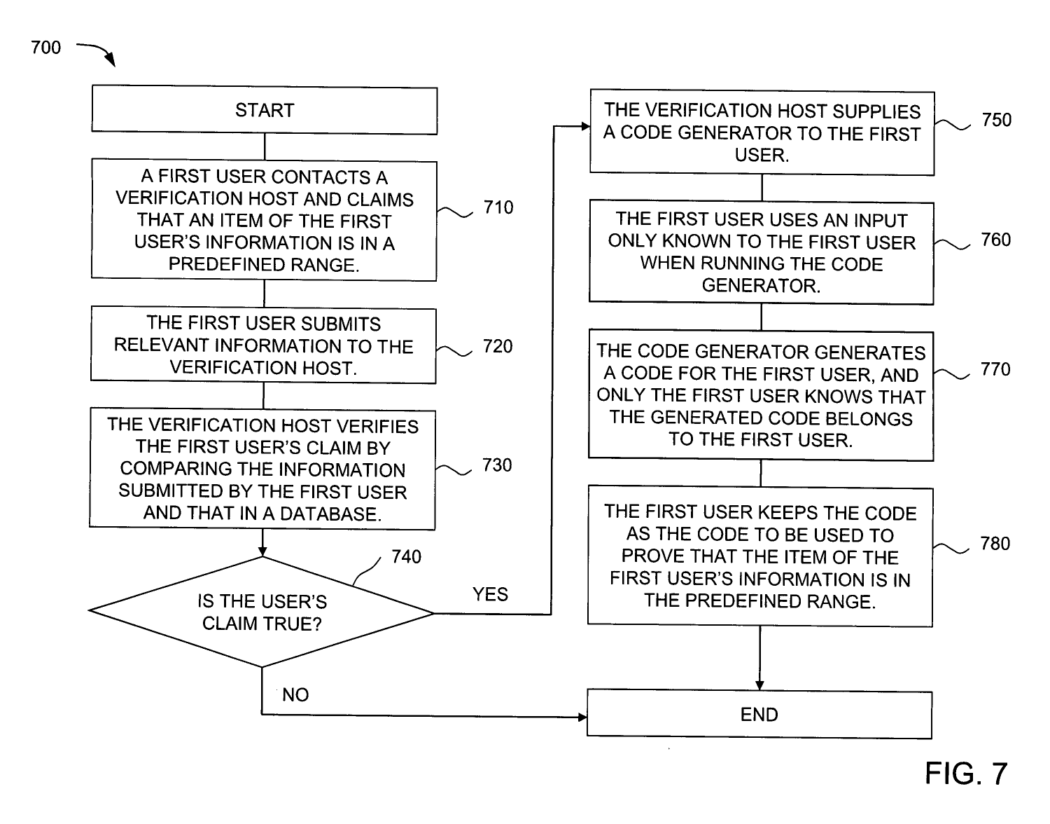

FIG. 7 illustrates an exemplary code generation process 700 in an implementation consistent with the principles of the invention. As illustrated, code generation process 700 may include step 710 through step 780. The number of steps, as illustrated in FIG. 7, is provided for simplicity. In practice, a typical code generation process could include more or less steps than illustrated in FIG. 7.

First user 120 may contact verification host 110 and claim that an item of first user 120's information falls into a predefined range in step 710. Then first user 120 may submit relevant information to verification host 110 in step 720. Then verification host 110 may verify first user 120's claim by comparing the information submitted by first user 120 and that in database 140 in step 730. If first user 120's claim is not true in step 740, code generation process 700 may end. If first user 120's claim is true, verification host 110 may supply code generator 170 to first user 120 in step 750. First user 120 may use an input only known to first user 120 when running code generator 170 in step 760. Code generator 170 may generate code 160 for first user 120, and only first user 120 knows that the generated code belongs to first user 120, in step 770. First user 120 may keep code 160 as a code to be used to prove that the item of first user 120's information falls into the predefined range in step 780. For example, first user 120 may write down code 160 on a piece of paper, or save code 160 to an electronic disk driver, to a USB (universal serial bus) memory stick, or to an intelligent card, etc.

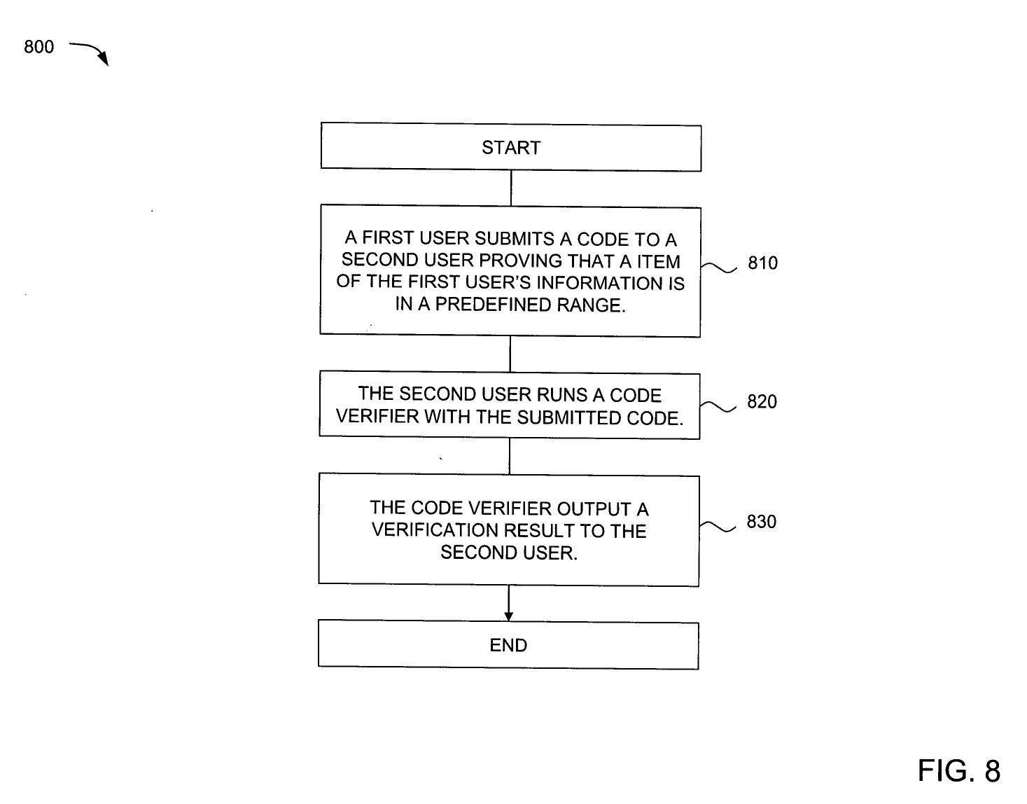

FIG. 8 illustrates an exemplary code verification process 800 in an implementation consistent with the principles of the invention. As illustrated, code verification process 800 may include step 810 through step 830. The number of steps, as illustrated in FIG. 8, is provided for simplicity. In practice, a typical code verification process could include more or less steps than illustrated in FIG. 8.

First user 120 may submit code 160 related to an item of information and/or a predefined range to second user 130 in step 810. Then second user 130 may run code verifier 180 with code 160 as an input in step 820. Code verifier 180 may output a verification result to second user 130. In one example, the verification result is the item of information is within the predefined range.

### Exemplary Process to Handle Code Abuse

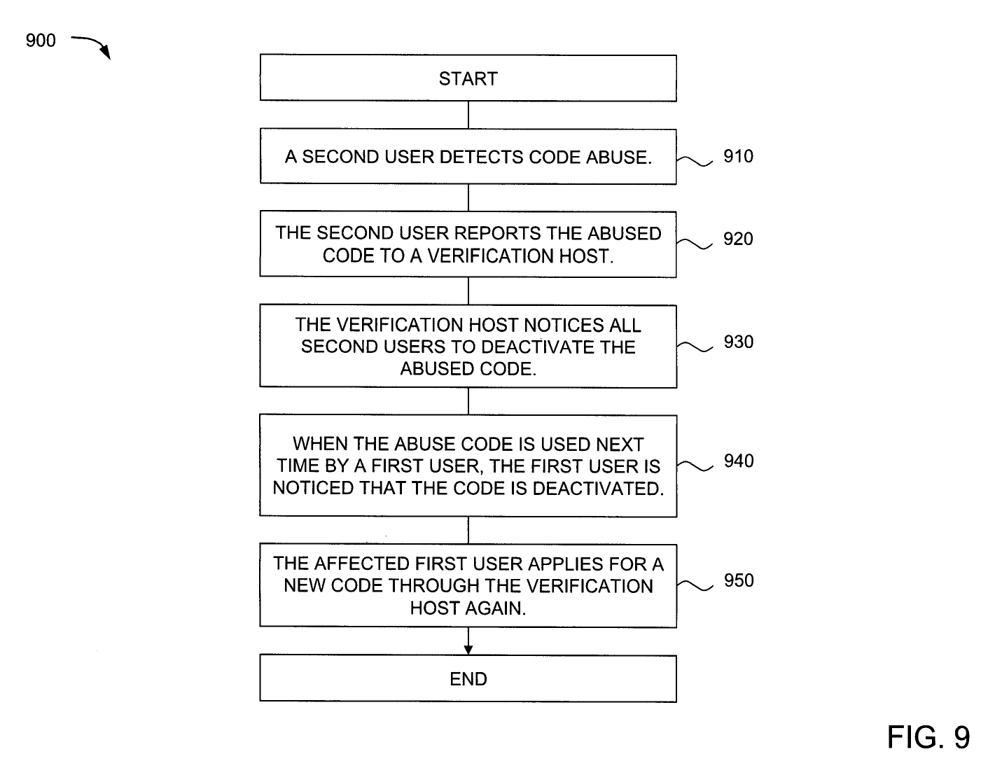

FIG. 9 illustrates an exemplary process 900 to handle code abuse in an implementation consistent with the principles of the invention. As illustrated, process 900 may include step 910 through step 950. The number of steps, illustrated in FIG. 9, is provided for simplicity. In practice, a typical process to handle code abuse could include more or less steps than illustrated in FIG. 9.

Second user 130 may detect code abuse in step 910. For example, when two consumers use the same code at the same time on the same service provider website, code abuse may be identified. Then second user 130 may report the abused code to verification host 110 in step 920. Then verification host 110 may notice all second users to deactivate the abused code in step 930. When first user 120 of the abused code uses the abused code next time, first user 120 may be noticed that the code has been deactivated in step 940. Finally the affected first user may apply for a new code through verification host 110 in step 950. For example, even though it is recommended that a code is not allowed to be used by anyone except the possessor, a consumer may borrow a code from a friend or steal a code. When both the consumer and the friend log onto a same website at the same time with the same code, the code verifier on the website may detect a case of code abuse.

### Exemplary Designs of Code Generator and Code Verifier

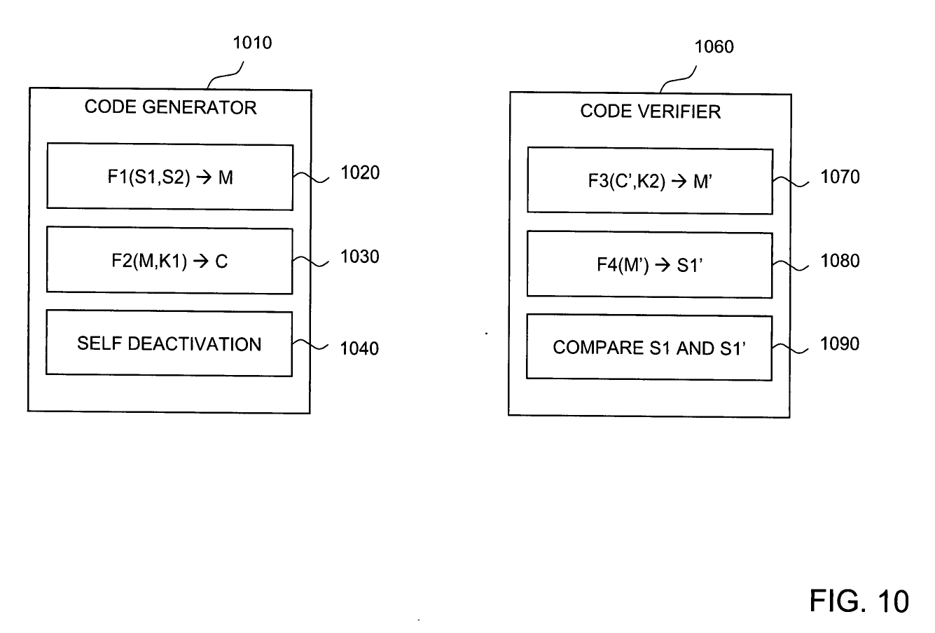

FIG. 10 illustrates an example of code generator 1010 and an example of code verifier 1060 in an implementation consistent with the principles of the invention. As illustrated, design 1010 may include module 1020 through module 1040; and design 1060 may include module 1070 through module 1090. The number of modules, illustrated in FIG. 10, is provided for simplicity. In practice, a typical design of a code generator and a typical design of a code verifier could include more or less modules than illustrated in FIG. 10.

Module 1020 may combine a string S1, which may be determined by verification host 110, and another string S2, which may be determined by first user 120, into a message string M through function F1. Module 1030 may encrypt the massage string M with an encryption key K1 into an encrypted code C through function F2. The encrypted code C may be assigned to first user 120 as first user 120's anonymous verification code. After the code is generated, module 1040 may deactivate code generator 910 to guarantee first user 120 may generate only one code for the same item of information and for the same range each time first user 120 contacts verification host 110. Module 1070 may decrypt a code C′, submitted by first user 120, with a decryption key K2 into a decrypted message string M′ through function F3. Module 1080 may select first portion S1′ from the decrypted message string M′ through function F4. Module 1090 may compare S1′ and S1, which comes with code verifier 180, to determine whether or not S1′ is consistent with S1. The verification of the code C′ may be declared successful when S1′ is consistent with S1. The verification of the code C′ may be declared a failure when S1′ is not consistent with S1.

A design consistent with the principles of the invention may have the following properties: (1) the code may be long enough, therefore the probability to guess a valid code may be extremely small; (2) the string the first user uses as the input to the code generator may be long enough, therefore the probability that two first users' codes are the same may be extremely small; (3) the code generator and the code verifier may be highly encrypted, therefore the probability to breakdown them by an unauthorized entity may be extremely small; (4) The code, the code generator and the code verifier may need to be renewed in every certain periods of time, therefore the probability to forge the code, the code generator and the code verifier by an unauthorized entity may be extremely small; and (5) the first user may have multiple codes for different items of information and different ranges and the second user may be able to verify multiple codes for different items of information, different ranges, and different first users.

### Exemplary Numerical Values

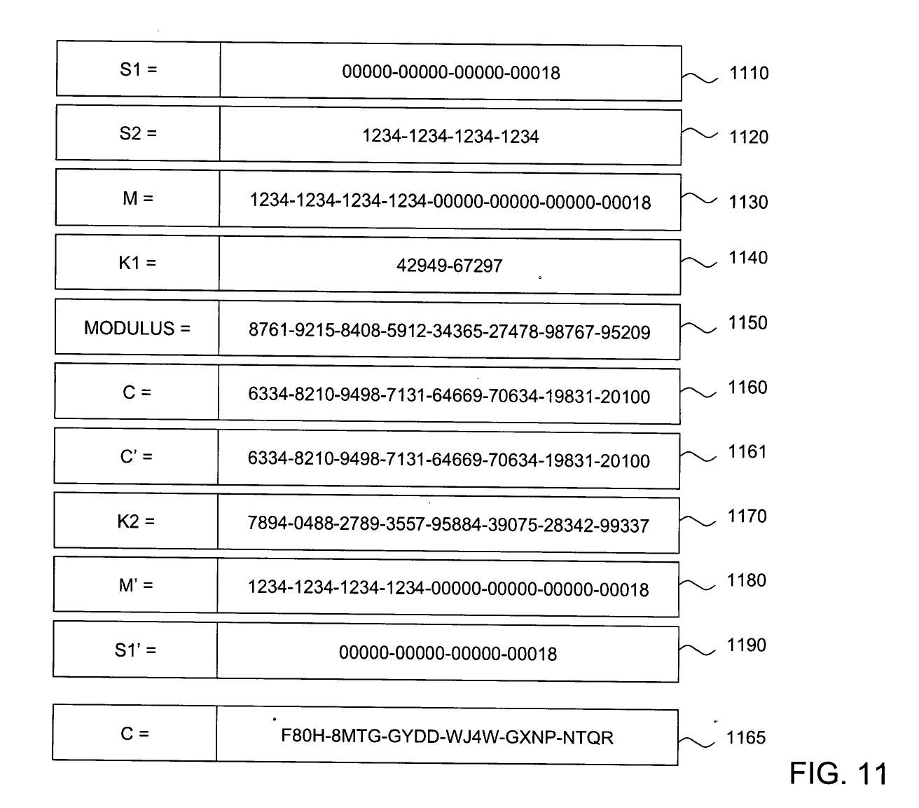

FIG. 11 illustrates an exemplary set of numerical values related to the code generation and the code verification. As illustrated, the exemplary set of numerical values may include value 1110 through value 1090. The values illustrated in FIG. 11 are provided for the example. In practice, the values could be very different from that illustrated in FIG. 11.

In FIG. 11 code generation and code verification are illustrated in a numerical example by using RSA (Rivest, Shamir, Adleman) Algorithm as the encryption and decryption algorithm. When a first user obtains a code generator after a verification host verifies that the first user's age is 18 or above, the code generator may contain a string determined by the verification host with value 1110 of a 20-digit number of 00000-00000-00000-00018 (S1). When the first user runs the code generator, the first user may choose value 1120 of a 16-digit number of 1234-1234-1234-1234 as the input string S2. The code generator may combine value 1110 and value 1120 into a combined message with value 1130 of a 36-digit number of 1234-1234-1234-1234-00000-00000-00000-00018 (M). Value 1140 of a 10-digit number of 42949-67297 may be chosen as encryption key K1 in RSA Algorithm. Value 1150 of a 36-digit number of 8761-9215-8408-5912-34365-27478-98767-95209 may be chosen as modulus for RSA Algorithm. Value 1160 of a 36-digit number of 6334-8210-9498-7131-64669-70634-19831-20100 (C) may be generated by the code generator and may be assigned to the first user as the code for the first user. Only the owner of the generated code, the first user, knows the identity of the owner of the code, no one else. When a second user wants to verify that the first user's age is 18 or above, the first user may submit value 1161 of the 36-digit number of 6334-8210-9498-7131-64669-70634-19831-20100 as the first user's code C′. Value 1170 of a 36-digit number of 7894-0488-2789-3557-95884-39075-28342-99337 may be used as decryption key K2 contained in the code verifier. Value 1180 of a 36-digit number of 1234-1234-1234-1234-00000-00000-00000-00018 (M′) may be obtained as a result when the second user runs the code verifier. Value 1190 of a 20-digit number of 00000-00000-00000-00018 (S1′) may be obtained by selecting the first portion of M′. In this example, S1 and S1′ match to each other, the code verification is successful. The second user is sure that the first user's age is 18 or above but no one in the world knows the identity of the first user in this verification process except the first user. If a first user inputs a wrong code or an arbitrary string as the code C′ to the code verifier, most likely the verification will fail based on the principle of this invention. Value 1160 is in Base10 (decimal) expression with a 36-digit number of 6334-8210-9498-7131-64669-70634-19831-20100. For the same code, if Base32 expression is used, only a 24-digit number 1110 of F80H-8MTG-GYDD-WJ4W-GXNP-NTQR may be enough as illustrated as value 1165. Using Base32 expression is an example to reduce the length of the code the first user needs to remember.

### Exemplary Implementations

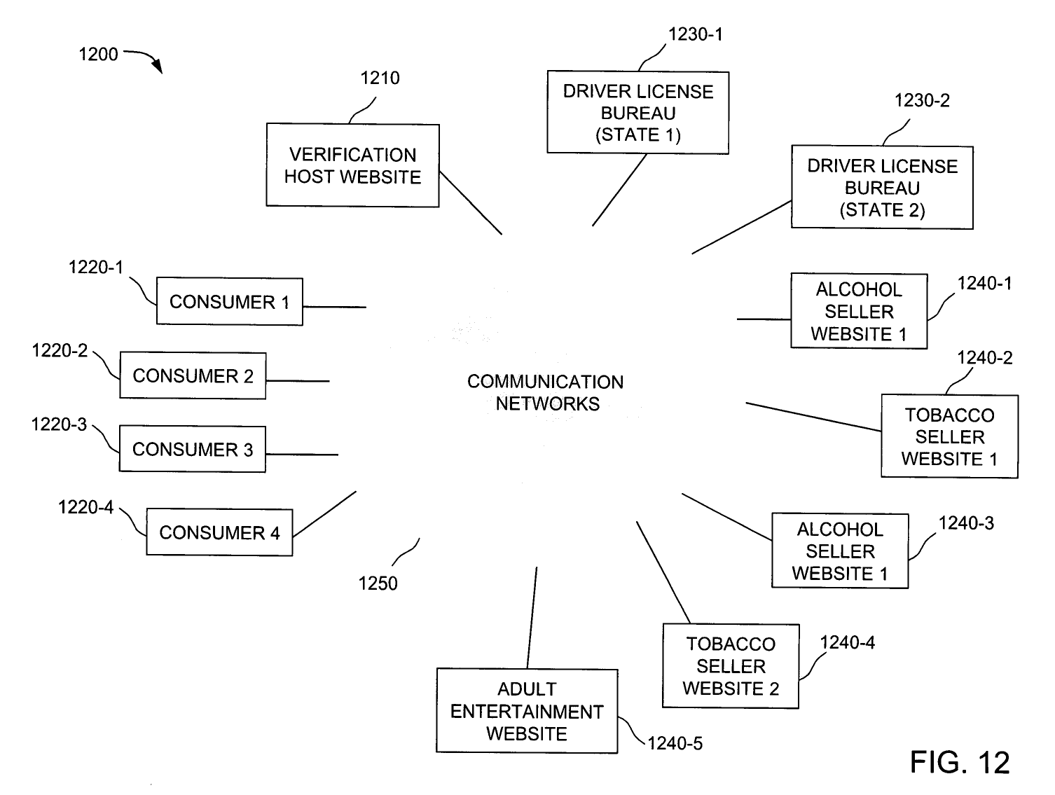

FIG. 12 illustrates an exemplary implementation 1200 in which various apparatus and methods, consistent with the principles of the invention, may be implemented. As illustrated, implementation 1200 may include communication networks 1250, consumers 1220 as first user 120 illustrated in FIG. 1, verification host website 1210 as verification host 110, driver license bureaus 1230 as database 140, and online service providers 1240 as second user 130. The number of communication networks, verification host websites, service providers, consumers, and driver license bureaus illustrated in FIG. 12 is provided for simplicity. In practice, a typical implementation could include more or fewer communication networks, verification host websites, service providers, consumers, and driver license bureaus than illustrated in FIG. 12.

In one implementation, consumer 1220 may contact verification host website 1210 for applying for a personal code for the proof of a particular item of personal information that falls into a predefined range, for example, the consumer's age is 18 or above. The consumer may submit his/her name, and/or driver license number, return email address, and/or other confirming information such as social security number, and the claim that the consumer's age is 18 or above to the verification host website 1210 via communication networks 1250. Verification host website 1210 may contact driver license bureau 1230 for verifying consumer 1220's claim via communication networks 1250. Driver license bureau 1230 may verify the claim and return a result YES or NO to verification host website 1210 via communication networks 1250. If the claim is not true, the result is NO, and consumer 1220's request may be denied. If the claim is valid, the result is YES, verification host website 1210 may provide a code generator to consumer 1220 via communication networks 1250. Consumer 1220 may generate a personal code by running the code generator with an input such as a randomly picked string. The code generator generates a code for consumer 1220. Consumer 1220 keeps the generated code as consumer 1220's personal code for the particular item of information and the particular range. Only consumer 1220 knows what the personal code is, no one else. Online service providers 1240 may contact verification host website 1210 for obtaining code verifiers via communication networks 1250. Verification host website 1210 may provide a code verifier to online service provider 1240 via communication networks 1205. With the code verifier service provider 1240 is able to verify the code submitted by consumer 1220. Consumer 1220 may contact service provider 1240 for a service which requires verification that an item of personal information of the consumer falls into a predefined range. Consumer 1220 may submit his/her personal code to service provider 1240. Service provider 1240 may verify the submitted personal code with the code verifier. If the verification of the submitted personal code is successful, service provider 1240 may grant the right of access to consumer 1220 for the service. Even though the service provider provides the service to the consumer, the service provider or anyone else is not able to verify the consumer's identity. If the verification of the submitted personal code is not successful, service provider 1240 may deny consumer 1220's request for the service.

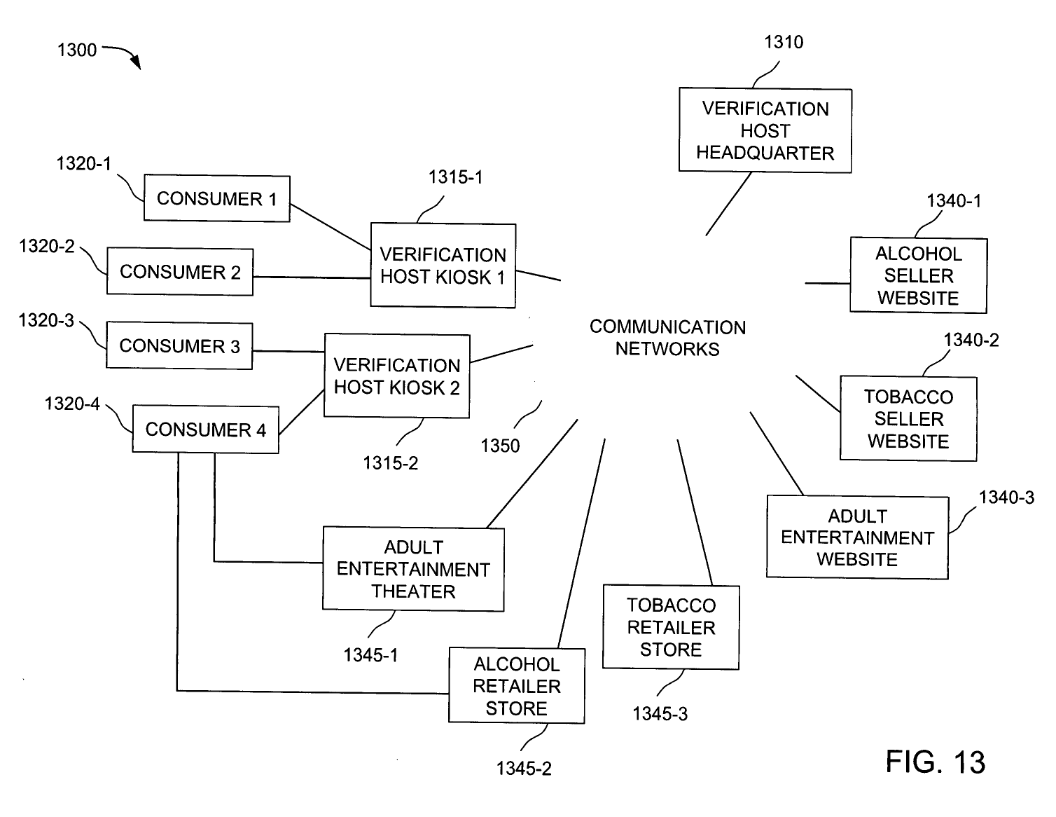

FIG. 13 illustrates another exemplary implementation 1300 in which systems and methods, consistent with the principles of the invention, may be implemented. As illustrated, implementation 1300 may include communication networks 1350, consumers 1320, verification host kiosks 1315, verification host headquarter 1310, online service providers 1340, and in-store service providers 1345. The number of communication networks, verification host kiosks, verification host headquarters, online service providers, in-store service providers, and consumers, as illustrated in FIG. 13, is provided for simplicity. In practice, a typical implementation could include more or fewer communication networks, verification host kiosks, verification host headquarters, online service providers, in-store service providers, and consumers than illustrated in FIG. 13.

In one implementation, consumer 1320 may contact verification host kiosk 1315 for applying for a personal code for a particular item of personal information, for example, age is 21 or above. Consumer 1320 may present the consumer's driver license to the staff in kiosk 1315. The staff in kiosk 1315 may verify consumer's claim about his/her age is 21 or above by checking the consumer's driver license. If the claim is not true the consumer's request may be denied. If the claim is true kiosk 1315 may provide a code generator to consumers 1320. Consumer 1320 may generate a personal code by running the code generator with a randomly picked string as an input. In another embodiment kiosk 1315 may be a part of a retailer store. Verification host kiosk 1315 may connect with verification host headquarter 1310 via communication networks 1350. Online service providers 1340 and in-store service providers 1345 may contact verification host headquarter 1310 for obtaining code verifiers via communication networks 1350. Verification host headquarter 1310 may provide the code verifier to online service providers 1340 and in-store service providers 1345. Consumers 1320 may use the personal code for accessing services provided by online service providers 1340 and/or in-store service providers 1345.

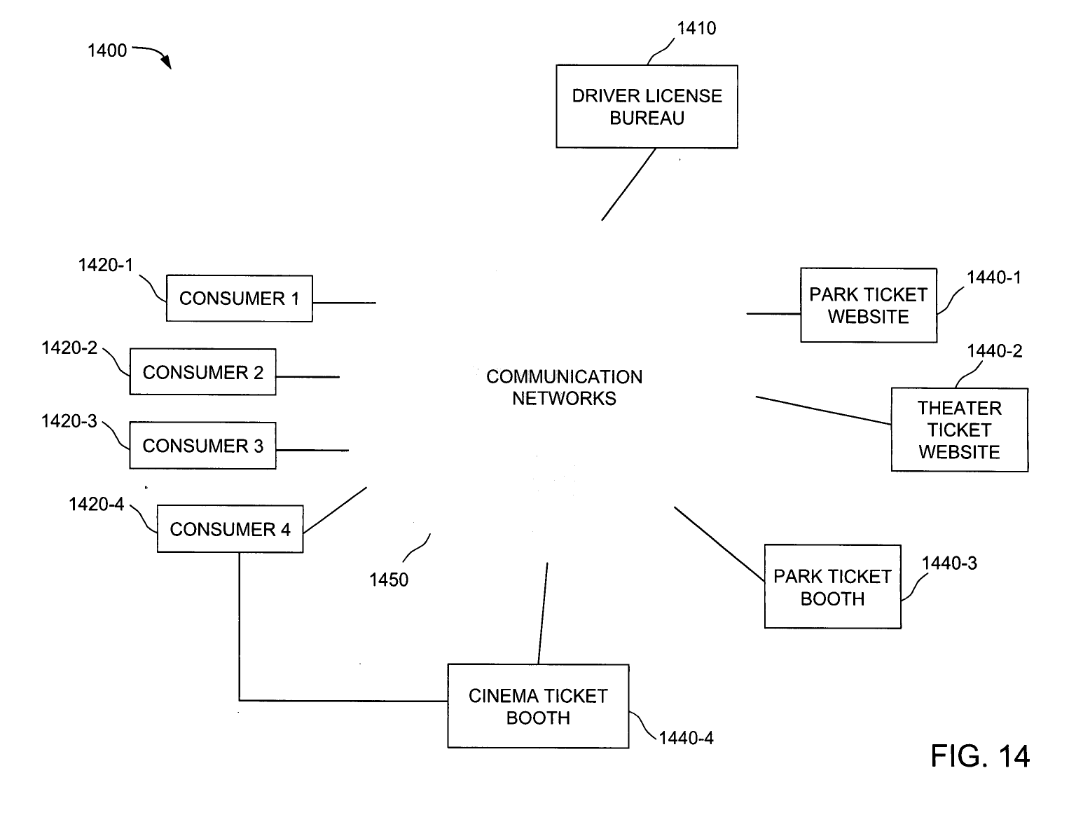

FIG. 14 illustrates yet another exemplary implementation 1400 in which systems and methods, consistent with the principles of the invention, may be implemented. As illustrated, implementation 1400 may include communication networks 1450, consumers 1420, driver license bureau 1410, and service providers 1440. The number of consumers, driver license bureaus, and service providers, as illustrated in FIG. 14 is provided for simplicity. In practice, a typical system could include more or fewer consumers, driver license bureaus, and service providers than illustrated in FIG. 14.

In one implementation, driver license bureau 1410 may act as a verification host. Consumers 1420 may contact driver license bureau 1410 to apply for a personal code which proves the consumer's claim that an item of the consumer's personal information falls into a predefined range, for example, the consumer's age is 55 or above. Consumer 1420 may submit consumer's name, driver license number, and return email address to driver license bureau 1410 via communication networks 1450. Driver license bureaus 1410 may verify the consumer's claim. If the claim is not true consumers 1420's request may be denied; if the claim is true driver license bureaus 1410 may provide a code generator to consumers 1420 via communication networks 1450. Consumers 1420 may generate a personal code by running the code generator with a randomly picked string as an input. Service providers 1440 may contact driver license bureau 1410 for obtaining one or more code verifiers via communication networks 1450. Driver license bureau 1410 may provide the code verifier to service providers 1440 via communication networks 1450.

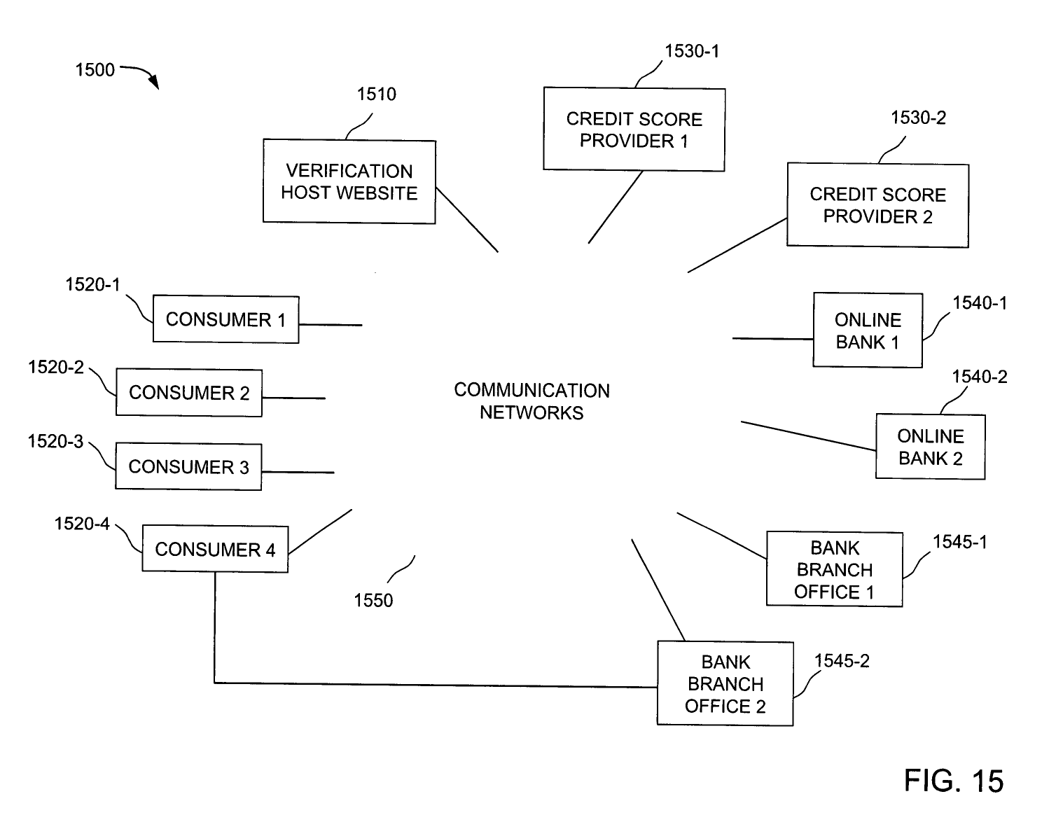

FIG. 15 illustrates still another exemplary implementation 1500 in which systems and methods, consistent with the principles of the invention, may be implemented. As illustrated, implementation 1500 may include communication networks 1550, consumers 1520, verification host website 1510, credit score providers 1530, online banks 1540, and bank branch offices 1545. The number of communication networks, consumers, verification host websites, credit score providers, online banks, and bank branch offices, as illustrated in FIG. 15 is provided for simplicity. In practice, a typical system could include more or fewer communication networks, consumers, code system websites, credit score providers, online banks, and bank branch offices than illustrated in FIG. 15.

In one implementation, consumer 1520 may contact verification host website 1510 for applying for a personal code which proves the consumer's claim that an item of the consumer's personal information falls into a predefined range, for example, the consumer's credit score is 700 or above. Verification host website 1510 may contact credit score providers 1530 to verify consumer 1520's claim. Credit score providers 1530 may verify consumer 1520's claim and may return a result of YES or NO to verification host website 1510 based on the result of the verification. Verification host website 1510 may deny consumer 1520's request if the result is NO. Verification host website 1510 may provide a code generator to consumer 1520 if the result is YES. Consumer 1520 may generate a personal code by running the code generator with a randomly picked string as an input. Online banks 1540 and bank branch offices 1545 may contact verification host website 1510 for obtaining one or more code verifiers via networks 1550. Verification host website 1510 may provide the code verifier to online banks 1540 and bank branch offices 1545. Consumers 1520 may use the personal code for service or services supplied by online banks 1540 and bank branch offices 1545.

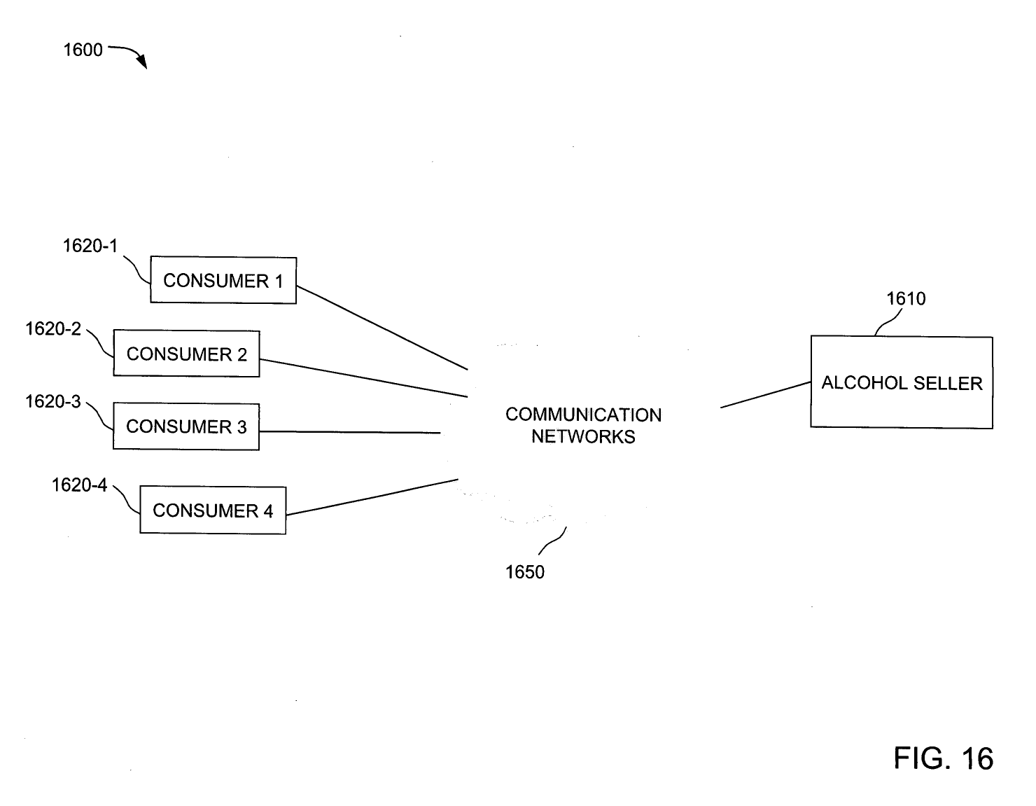

FIG. 16 illustrates yet another exemplary implementation 1600 in which systems and methods, consistent with the principles of the invention, may be implemented. As illustrated, implementation 1600 may include communication networks 1650, consumers 1620, and service providers 1610. The number of networks, consumers, and service providers, as illustrated in FIG. 16 is provided for simplicity. In practice, a typical system could include more or fewer networks, consumers, and service providers than illustrated in FIG. 16.

In one implementation, service provider 1610, an alcohol seller as an example here, may act as a verification host, a database, and a service provider. Consumers 1620 may contact service provider 1610 first to apply for a personal code which proves the consumer's claim that an item of the consumer's personal information falls into a predefined range, for example, the consumer's age is 21 or above. Consumer 1620 may submit consumer's name, driver license number, and return email address to service provider 1610 via communication networks 1650. Service provider 1610 may verify the consumer's claim. If the claim is not true consumers 1620's request may be denied; if the claim is true service provider 1610 may provide a code generator to consumers 1620 via communication networks 1650. Consumers 1620 may generate a personal code by running the code generator with a randomly picked string as an input. Service providers 1610 may have a code verifier to verify a code submitted by consumer 1620, when service provider is not able to know the identity of the code possessor.

### CONCLUSION

Implementations consistent with the principles of the invention provide the method and the system verifying information anonymously. The method and system include the verification host, the first user, the second user, the database, the code, the code generator, and the code verifier. The purpose of the method and system is to perform the anonymous information verification. Only the first user, the owner of the code, not anyone else, knows that the code belongs to the first user. Therefore the first user's identity and privacy are fully protected when the second user verifies the code submitted by the first user.

The item of the first user's information may include, but not limit to, age, birth place, home state, marriage status, income level, credit score, criminal record, revenue, total years of experience of an executive team, etc. The first user may have more than one code for different items of information and/or different ranges. The second user may have more than one code verifier for same or different items of information, and same or different ranges. The method and system may be used for various types of anonymous information verification, including commercial or non-commercial services. The method and system may be used for online interaction and face-to-face interactions between the first user and the second user.

The foregoing description of exemplary implementations of the invention provides illustration and description, but is not intended to be exhaustive or to limit the invention to the precise form disclosed. Modifications and variations are possible in light of the above teachings or may be acquired from practice of the invention. For example, while a structure of system, including the verification host, the first user, the second user, the database, the code, the code generator, and the code verifier are described above, it will be appreciated that the techniques described herein are equally applicable to other types of structures for verifying information anonymously.

While a series of steps has been described with respect to FIG. 2, FIG. 7, FIG. 8, FIG. 9, FIG. 12, FIG. 13, FIG. 14, FIG. 15, and FIG. 16, the order of the steps may be varied in other implementations consistent with the invention. Moreover, non-dependent steps may be implemented in parallel.

It will be apparent to one of ordinary skill in the art that aspects of the invention, as described above, may be implemented in many different forms of software, firmware, and hardware in the implementations illustrated in the figures. The actual software code or hardware used to implement aspects consistent with the principles of the invention is not limiting of the invention. Thus, the operation and behavior of the aspects of the invention were described without reference to the specific software—it being understood that one of ordinary skill in the art would be able to design software and hardware to implement the aspects based on the description herein.

Further, certain portions of the invention may be implemented as “logic” that performs one or more functions. This logic may include hardware, software, or a combination of hardware and software.

No element, act, or instruction used in the description of the present application should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. A user verification method, comprising:
verifying an item of information, associated with a first user, is within a predefined range;
providing a code generator to the first user after the verifying, wherein the code generator includes no first user information;
generating a code for the first user by the code generator; and
running a code verifier with an input of the code from the first user, resulting in a verification of the item of information is within the predefined range.

2. The method of claim 1, wherein only the first user knows that the code generated by the code generator belongs to the first user.

3. The method of claim 1, wherein the verifying and the providing comprise verifying the item of information, associated with the first user, is within the predefined range, and providing the code generator to the first user by a verification host, respectively.

4. The method of claim 1, wherein the providing of the code generator to the first user comprises inputting a first set of data to the code generator.

5. The method of claim 1, wherein the generating of the code comprises inputting a second set of data to the code generator by the first user.

6. The method of claim 1, wherein the code verifier is provided by the verification host and comprises no information associated with the first user.

7. The method of claim 1 further comprises deactivating the code generator after the generating of the code.

8. The method of claim 1, wherein the item of information is selected from the group consisting of age, gender, address, birth place, home state, marriage status, income level, asset, credit score, criminal record, revenue, debt, and combinations thereof.

9. The method of claim 1 further comprises dealing with code abuse, wherein detecting code abuse when the verifying of the code;
reporting the code abuse to the verification host;
noticing the second users to deactivate the abused code;
noticing the first user using the abused code the code is deactivated; and
applying for a new code generator.

10. A user verification apparatus comprising:
a code generator designed to generate a code associated with an item of information of a first user is in a predefined range to be verified, wherein the code generator is run by the first user with an input only known to the first user; and
a code verifier designed to receive the code and generate a confirmation that the item of information of the first user is within the predefined range, wherein the code generator and code verifier include no the first user's information.

11. The apparatus of claim 10, wherein the code generator comprises:
a generating module designed to generate a third set of data based on a first set of data incorporated with the code generator by a verification host and a second set of data provided by the first user;
an encryption module designed to provide the code by encrypting the third set of data; and
a self-deactivation module designed to deactivate the code generator after generating a predefined number of codes.

12. The apparatus of claim 10, wherein the code verifier comprises:
a decryption module designed to decrypt a code provided by a first user to produce a fourth set of data;
an extraction module designed to extract a fifth set of data from the fourth set of data; and
a matching module designed to use the fifth set of data to verify the item of information is within a predefined range.

13. The apparatus of claim 12, wherein the matching module is designed to compare the fifth set of data with the first set of data incorporated with the code generator by the verification host.

14. A system for user verification, comprising:
a first user;
a second user requesting a verification of the first user if an item of information associated with the first user is within a predefined range; and
a verification host providing a code generator to the first user after verifying the item of information associated with the first user is within the predefined range, and providing a code verifier to the second user.

15. The system of claim 14, wherein the first user requests the code generator, generates the code with the code generator with an input only known to the first user, and submits the code to the second user when the second user verifies the item of information associated with the first user is within the predefined range.

16. The system of claim 14, wherein the second user verifies the code submitted by the first user with the code verifier.

17. The system of claim 14, further comprising a verification database having the item of information associated with the first user.

18. The system of claim 14, further comprising a mechanism coupling the first user, the second user and the verification host and providing a communication mechanism among them.

19. The system of claim 14, wherein the code generator and the code verifier contain no information of the first user.

20. The system of claim 14, wherein the code contains a first portion determined by the verification host and a second portion determined by the first user.
